(19) United States
(12) Patent Application Publication
(10) Pub. No.: US 2017/0298849 A1
(43) Pub. Date: Oct. 19, 2017

(54) SYSTEM AND METHOD FOR ENHANCED OPERATOR CONTROL OF FUEL SAVING MODES

(71) Applicant: Ford Global Technologies, LLC, Dearborn, MI (US)

(72) Inventors: Tuan Anh Be, Livonia, MI (US); Mark Douglas Malone, Canton, MI (US); Nicholas Colella, Grosse Ile, MI (US); Allen R. Murray, Lake Orion, MI (US)

(21) Appl. No.: 15/130,610

(22) Filed: Apr. 15, 2016

(51) Int. Cl. F02D 41/02; B60K 35/00; B60J 1/00; B60R 11/02; B60N 2/56

(52) U.S. Cl. CPC F02D 41/021; B60R 11/0264; B60N 2/5678; B60J 1/002; B60K 35/00; B60K 2350/1004

(57) ABSTRACT

The present disclosure generally relates to a system and method for providing enhanced operator-controlled fuel saving modes for a vehicle to optimize fuel economy of a vehicle. In one embodiment, the fuel saving optimization system and method enables the operator to create fuel saving configurations which include operator input as to how to operate one or more devices while the vehicle is within a specific locale and under a specific conditions or in response to specific event occurring. The fuel saving optimization system stores each created fuel saving configuration for a future use, and executes each fuel saving configuration when the vehicle is under the specified conditions. In certain embodiments, the input is provided by the operator in real time or can be retrieved via past travel history data on a particular route which is stored in a database.

### TECHNICAL FIELD

The present disclosure generally relates to a system and method for providing enhanced operator controlled fuel saving modes for an automotive vehicle.

### BACKGROUND

In the automotive industry, vehicles include a common, “one-size, fits-all” solution for optimization of fuel saving mode(s) in the vehicle. More specifically, such systems include fuel saving settings that are designed to appease the greatest number of possible customers.

There are various scenarios where additional fuel saving modes may be utilized to enhance fuel economy and vehicle performance. Accordingly, there is a need for a system that provides customization of fuel saving mode setting to optimize fuel saving modes for vehicles.

### SUMMARY

The appended claims define this application. The Specification summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Various embodiments of the present disclosure provide a system and method for providing enhanced operator-controlled fuel saving modes for a vehicle to optimize fuel economy of a vehicle under certain operator-defined criteria. More specifically, the operator controlled fuel saving system and method of the present disclosure (referred to throughout this specification as the fuel saving optimization system for brevity) enables an operator to customize fuel saving settings for the vehicle when the vehicle is under certain specified conditions. Various embodiments of the present disclosure fit well with existing vehicle fuel saving systems such as, but not limited to, engine start-stop systems and hybrid systems.

In one embodiment, the fuel saving optimization system and method includes enabling the operator to create fuel saving configurations which include operator input as to how to operate one or more devices while the vehicle is within a specific locale and under a specific conditions or in response to specific event occurring. After enabling the operator to create a fuel saving configuration, the fuel saving optimization system stores each created fuel saving configuration for a future use, and executes each fuel saving configuration when the vehicle is under the specified conditions. In certain embodiments, the input is provided by the operator in real time or can be retrieved via past travel history data on a particular route which is stored in a database. In certain embodiments, the operator can choose the stored preference according to the route traversed or the vehicle can adapt or learn the preference over time.

As such, the fuel saving optimization system and method uses knowledge of real time vehicle running conditions along with operator input to execute customized fuel saving configurations for optimized fuel economy for each specific operator.

### BRIEF DESCRIPTION OF THE DRAWINGS

For a better understanding of the invention, reference may be made to embodiments shown in the following drawings. The components in the drawings are not necessarily to scale and related elements may be omitted to emphasize and clearly illustrate the novel features described herein. In addition, system components can be variously arranged, as known in the art. In the figures, like referenced numerals may refer to like parts throughout the different figures unless otherwise specified.

FIG. 1A is a flowchart of an example process of operating the fuel saving optimization system of the present disclosure to create and store a fuel saving configuration according to one embodiment of the present disclosure.

FIG. 1B is a flowchart of an example process of operating the fuel saving optimization system of the present disclosure to execute a fuel saving configuration according to one embodiment of the present disclosure.

FIG. 1C is a flowchart of an example process of operating the fuel saving optimization system of the present disclosure to provide recommended fuel saving configurations according to one embodiment of the present disclosure.

FIGS. 2A to 2E illustrate screenshots of a vehicle display according to one embodiment of the present disclosure.

FIGS. 3A to 3B illustrate screenshots of a vehicle display according to one embodiment of the present disclosure.

FIG. 4 illustrates a block diagram of one embodiment of a vehicle control system including a fuel saving optimization system.

### DETAILED DESCRIPTION OF EXAMPLE EMBODIMENTS

While the system and method for providing enhanced operator controlled fuel saving modes (referred to throughout this specification as the fuel saving optimization system for brevity) of the present disclosure may be embodied in various forms, the Figures show and this Specification describes some exemplary and non-limiting embodiments of the fuel saving optimization system. The present disclosure is an exemplification of the fuel saving optimization system and does not limit the fuel saving optimization system to the specific illustrated and described embodiments. Not all of the depicted or described components may be required, and some embodiments may include additional, different, or fewer components. The arrangement and type of the components may vary without departing from the spirit or scope of the claims set forth herein.

Various embodiments of the present disclosure provide a fuel saving optimization system that enables operators to tailor fuel saving configurations specific to their usage of the vehicle. Such a configuration provides enhanced fuel economy settings rather than the “one-size, fits-all” fuel saving mode settings that are designed to appease the greatest number of possible customers. Customers in the real world do not utilize the vehicle or fuel saving modes in an equivalent manner. In fact if given the ability, the operator may well be able to indicate their preference in a meaningful way for a given situation better then might be determinable by any factory setting/or otherwise pre-defined algorithm.

An operator is uniquely situated to provide certain inputs for fuel saving systems where that specific operator may be able to preserve fuel where other operators may not be. These inputs may be related to when the vehicle is within certain locations, or when the vehicle encounters certain events, or when the vehicle is subjected to certain environments with a particular operator. The fuel saving optimization system and method of the present disclosure utilizes the knowledge of vehicle conditions and operator signaled inputs to adapt or learn the operator's preference for optimization of the fuel saving mode at specific locales (using data acquired from Geofencing, GPS, or and many other technologies of identifying a location), at specified time, under current environmental conditions (rain, snow, day/night, etc.) under detected traffic condition (average speed, congestion, etc.), or pre-programmed usage pattern. Such a configuration provides enhanced fuel economy that is customized by the particular operator for that operator's particular use.

For example, consider the existing fuel saving algorithms that provide control of Engine State (On or Off) in order to save fuel while idling such as Stop-Start. In such systems, it is not uncommon to limit the engine-off time to a statically defined maximum period, or to command engine restart based on present electrical functionality being provided, or based upon present evaluation of the battery's state of charge. This is to provide the most versatile fuel saving modes for all potential operators of a vehicle. In such a system, there is a lot of waste of fuel for individual operators that are using the vehicle in a specific manner. Using the fuel saving optimization system and method of the present disclosure, an operator can create a fuel saving configuration customized for the operator's specific use of the vehicle.

More specifically, in one embodiment, the fuel saving optimization system of the present disclosure enables an operator to create a fuel saving configuration, by specifying fuel saving settings such as: vehicle mode of behavior (i.e., location/timing/setting of the vehicle when the fuel saving configuration is to be activated), triggering events (i.e., events or conditions under which the fuel saving configuration is to be activated), and operations of one or more devices (i.e., turn on, turn off, idle). As such, for the example described above, pursuant to a fuel saving configuration created by the operator, when the operator exits the vehicle while the engine is auto-stopped, the fuel saving optimization system of the present disclosure will automatically restart the engine after an operator-specified duration when the operator will be absent for a certain period of time, but nearby and would rather it stay in the off mode—saving fuel.

In certain embodiments, perhaps the operator desires the radio and lighting to be turned off while making a delivery. In other embodiments, perhaps an operator would prefer unnecessary or chosen high power consumption devices such as heated seats or heated windscreen to be off while outside the vehicle. In another embodiment, an operator may want the wipers to be off while loading a passenger in a shuttle in rainy/snowy conditions. The fuel saving optimization system of the present disclosure enables the operator to create such fuel saving configurations, store each created fuel saving configuration for a future use, execute each fuel saving configuration, and offload the fuel saving configuration.

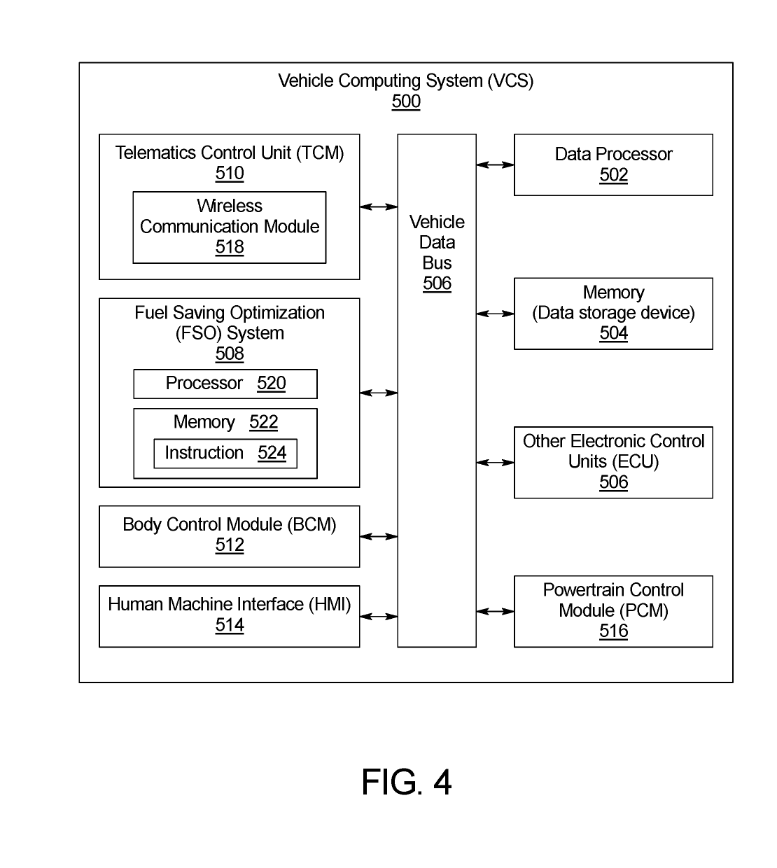

In certain embodiments, after an operator creates a fuel saving configuration, the fuel saving optimization system enables the operator to store the fuel saving configuration for later retrieval, and execute fuel saving configuration. In certain embodiments, once a fuel saving configuration has been stored within a memory of the vehicle control system (such as those described in connection with FIG. 4 below), the fuel saving optimization system of the present disclosure automatically executes a fuel saving configuration when the specific settings are met. In other embodiments, the fuel saving optimization system of the present disclosure notifies an operator when a particular fuel saving configuration is implicated based on vehicle location/conditions, and enables to operator to execute or modify the implicated fuel saving configuration. In another example embodiment, the fuel saving optimization system enables a operator to offload the data

The fuel saving optimization system thereby utilizes information about vehicle conditions and operator signaled inputs to optimize the fuel saving modes for example, at specific locales, at specified time, under current environmental conditions or detected traffic conditions, or under a pre-programmed usage pattern. Such a configuration is useful for fuel economy for an individual operator as well as for classes of operators such as for fleets, delivery vehicles, military vehicles, shuttles, etc.

Accordingly, the fuel saving optimization system of the present disclosure provides a system and a method for enabling an operator to create customized fuel saving configurations based on an operator's inputs, and activating the customized fuel saving modes under certain specified conditions.

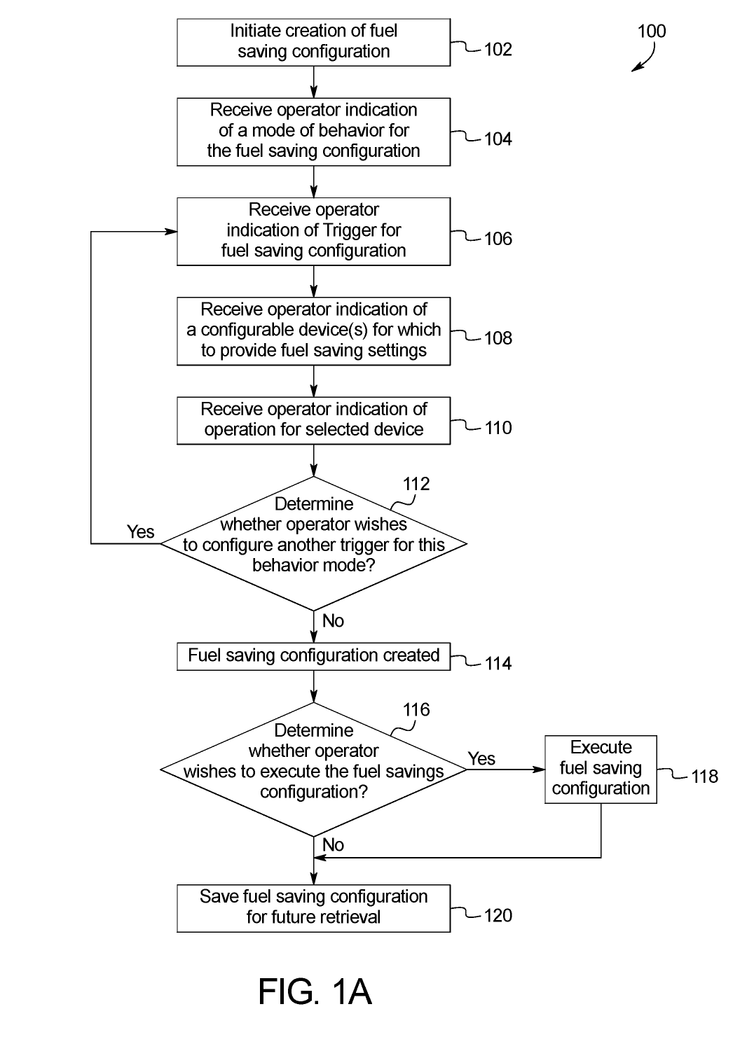

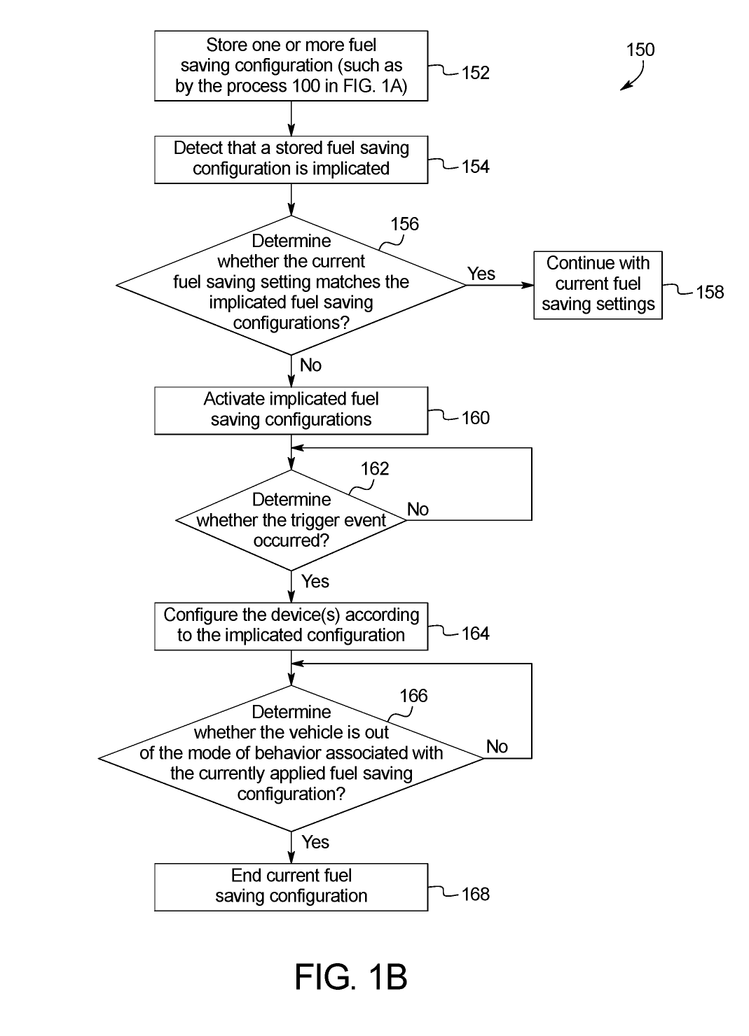

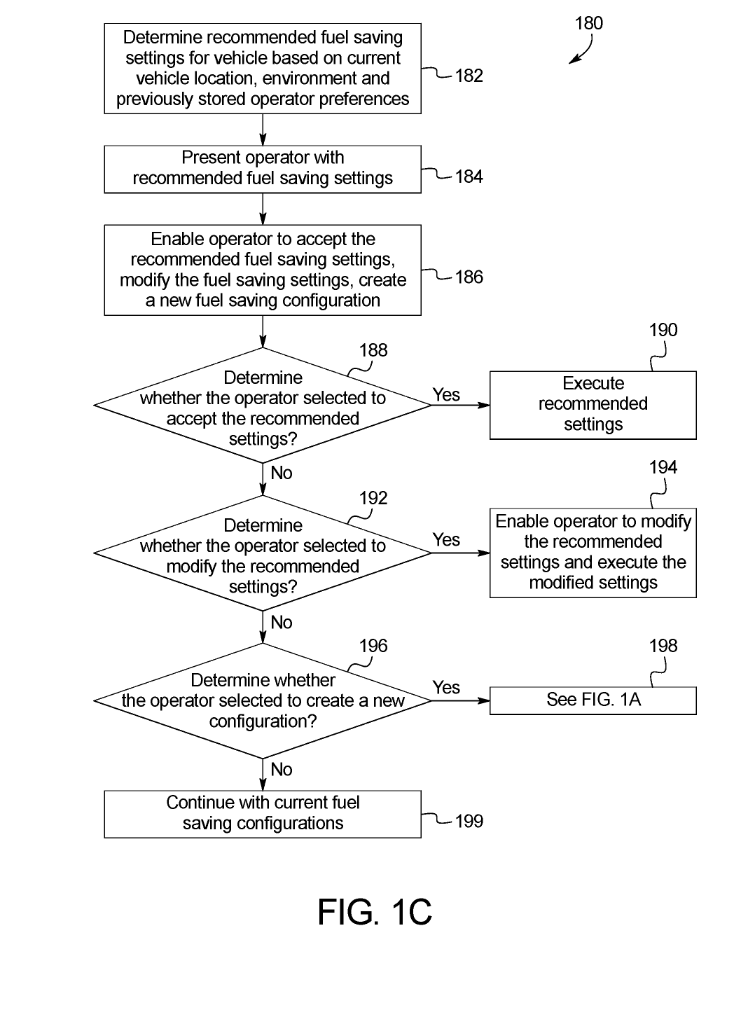

FIG. 1A illustrates a flow chart of an example process or method 100 of operating the fuel saving optimization system of the present disclosure. In various embodiments, process 100 is represented by a set of instructions stored in one or more memories and executed by one or more processors (such as those described in connection with FIG. 4). Although process 100 is described with reference to the flowchart shown in FIG. 1A, many other processes of performing the acts associated with process 100 may be employed. For example, the order of certain of the illustrated blocks may be changed, certain of the illustrated blocks may be optional, or certain of the illustrated blocks may not be employed.

In operation of this embodiment, the process 100 for operating the fuel saving optimization system includes creating a fuel saving configuration, as indicated by block 102. More specifically, a fuel saving configuration indicates a particular fuel saving operation for certain specific devices under certain specific conditions. In certain embodiments, the vehicle includes certain factory default settings for fuel saving configurations that the fuel saving optimization system employs unless the operator specifies otherwise. In one example of such an embodiment, to customize these factory default settings, the fuel saving optimization system of the present disclosure notifies the operator that the vehicle is operating under default factory fuel saving settings, and enables the operator to create a new fuel saving configuration.

To better understand the process of creating a fuel saving configuration according to this example embodiment of the present disclosure, consider an example embodiment whereby an operator of a delivery truck wishes to create a new fuel saving configuration for use during deliveries. In this example embodiment, the fuel saving optimization system receives operator settings for fuel saving configurations through a vehicle operator interface such as a human to machine interface (HMI).

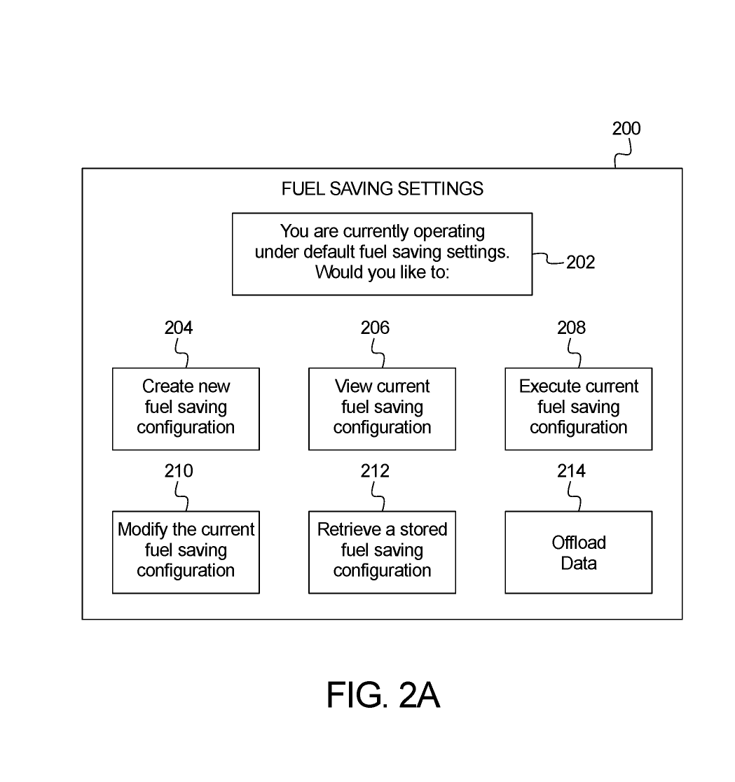

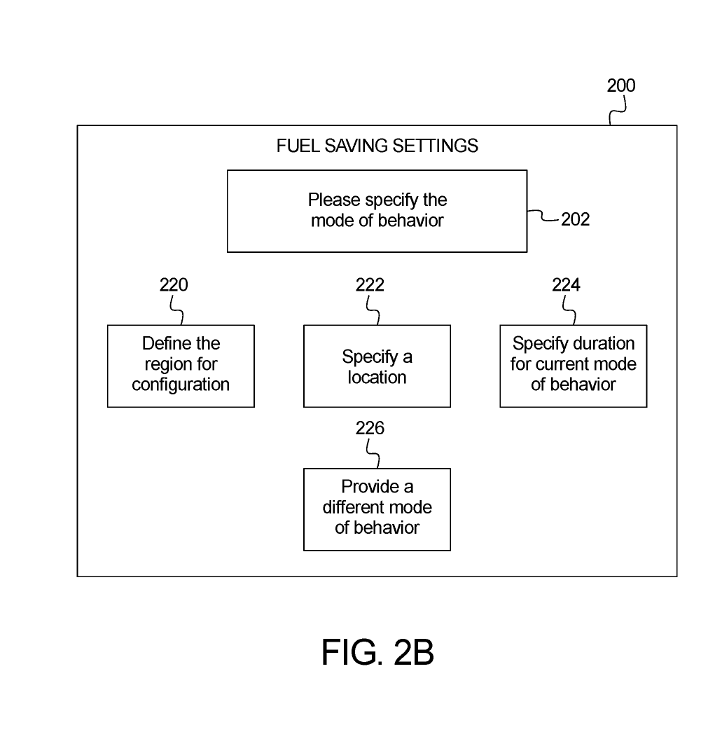

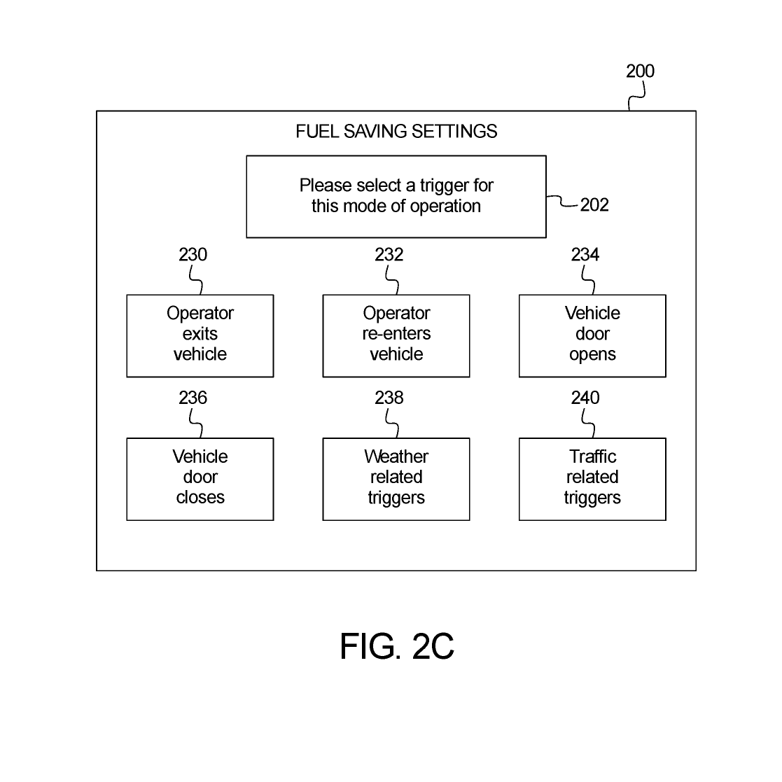

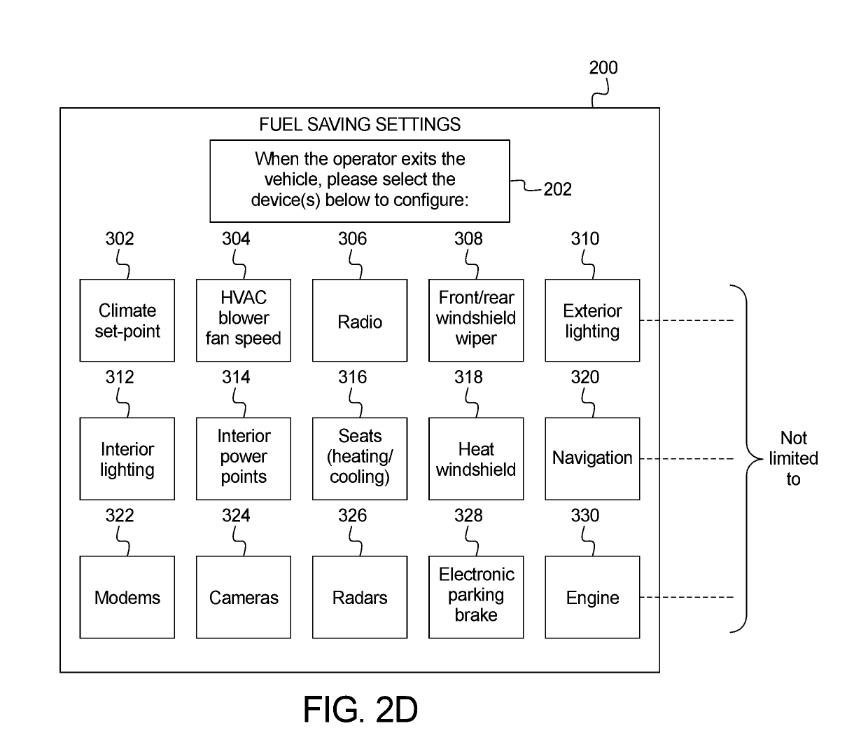

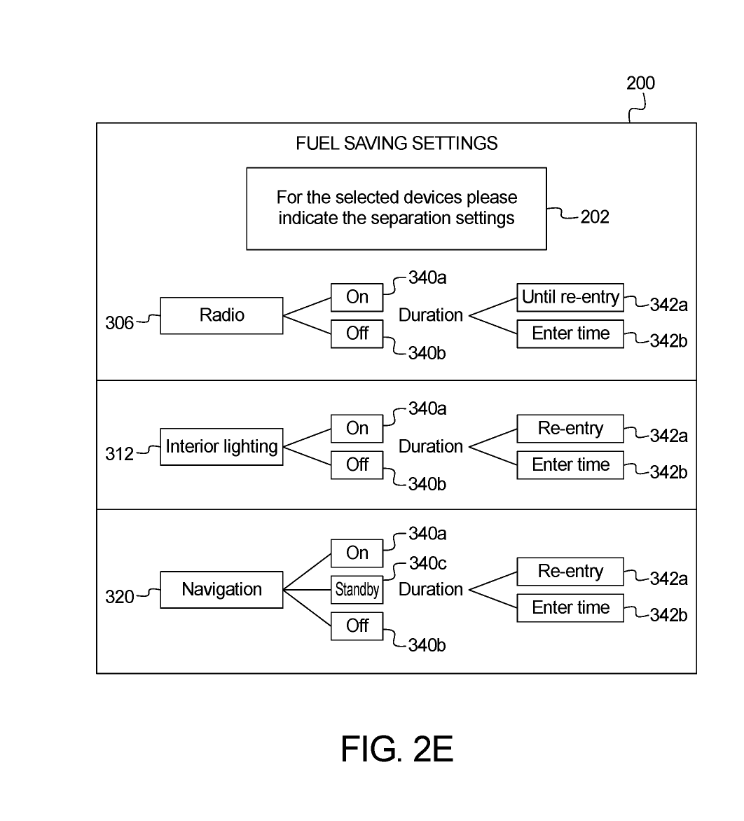

FIGS. 2A to 2E, illustrate a series of screen shots of an HMI display 200 according to this example embodiment. It should be appreciated that the example embodiment is merely an illustration of one embodiment of operating the fuel saving optimization system of the present disclosure. In certain alternative embodiments, the fuel saving optimization system may include a different manner of presenting the various options for the fuel saving optimization inputs such as by including more, less, or different inputs for the operator to select. In other embodiments, the fuel saving optimization system may include different menu options or different interface for the operator.

FIG. 2A illustrates a screen shot of a “Fuel Saving Settings” home screen according to this example embodiment. The display 200 includes a message box 202, which states: “YOU ARE CURRENTLY OPERATING UNDER DEFAULT FUEL SAVING SETTINGS, WOULD YOU LIKE TO:,” and lists the options available to the operator for this embodiment. Below the message box 202, the display 200 includes several inputs 204, 206, 208, 210, 212, 214 that the operator may select. In this example embodiment, the selectable fuel saving menu options include: (1) “Create new fuel saving configuration,” as indicated by 204, (2) “View Current Fuel Saving Configuration,” as indicated by 206, (3) “Execute current fuel saving configuration,” as indicated by 208, (4) “Modify the current fuel saving configuration,” as indicated by 210, (5) “Retrieve a stored fuel saving configuration,” as indicated by 212, and (6) “Offload data,” as indicated by 214. Each of these inputs will be described in greater detail below. It should be appreciated that in certain alternative embodiments a “Fuel Saving Settings” home screen may include fewer, more, or different inputs for the operator to select.

In certain embodiments, the fuel saving optimization system enables the operator to create a fuel saving configuration by selecting an existing default fuel saving configuration and modifying it based on the operator's unique preferences. For example, in this embodiment, the operator may select to view the current fuel saving configuration (such as by selecting input 206), and either execute the current fuel saving configuration (such as by selecting input 208) or modify the current fuel saving configuration (such as by selecting input 210). Alternatively, the operator may retrieve any existing fuel saving configurations by selecting input 212. In certain embodiments, the operator creates new fuel saving configurations completely based on the operator's preference (such as by selecting input 204), as described in greater detail below. The final input depicted in FIG. 2A is for offloading data, as indicated by input 214. As described in greater detail below, the operator may select this input to save any fuel saving configurations from the fuel saving optimization system to an internal or external application that can process the data and provide optimization for usage during the next occurrence. Furthermore, such information may be utilized for setting on fuel economy that can be achieved for other similarly situated vehicles (i.e., fleets, delivery vehicles, military vehicles, shuttles).

In this example embodiment, the delivery truck operator initiates creation of a fuel saving configuration by selecting input 204 “Create a new fuel saving configuration,” as described above. In this example embodiment the HMI display 200 is a touch screen that enables the operator to simply touch any of the inputs described above to select the input.

Turning back to FIG. 1A, after selecting to create a new fuel saving configuration, the process 100 includes receiving an operator indication of a mode of behavior for the fuel saving configuration, as indicated by block 104. A mode of behavior defines the location and/or timing under which the fuel saving configuration is to be activated. In certain embodiments, the mode of behavior is defined as a certain area, such as by a creating a geofence (or a virtual barrier) or an advanced driver assistance system (ADAS). More specifically, in one embodiment, the vehicle control system includes a program that incorporate geo-fencing by allowing an administrator to set up triggers so when the vehicle enters (or exits) the boundaries defined by the administrator, a notification is sent to the fuel saving optimization system. A few examples of modes of behavior include but are not limited to, while the vehicle is within a predefined location or region, operating on highways, freeways, in a sub-division, in urban areas, or on surface streets. The fuel saving optimization system determines whether the vehicle is within a particular mode of operation using GPS-based query of ADAS-like systems to identify when the chosen operating zones are present. Other examples include when operator stops the vehicle in his driveway, at a delivery point or other destination, which the vehicle determines either by GEOFENSE or GPS.

Turing to FIG. 2B, in this example embodiment, after the operator selects to configure a new fuel saving configuration, the fuel saving optimization system enables the operator to select the mode of behavior through selection of one or more of the input options depicted on the display 200. The message box 202 states “PLEASE SPECIFY THE MODE OF BEHAVIOR.”

In certain embodiments, the operator selects to activate the fuel saving configuration when the vehicle is within the specified area, such as by selecting input 220, “Define the Region for Configuration.” In other embodiments, the operator may define the mode of behavior as a pre-specified location, such as by selecting input 222, “Specify a Location.” In such an embodiment, the fuel saving configuration is to be activated when the vehicle reaches the specified location. In another embodiment, the operator may wish to define a mode of behavior to be the real-time conditions of the vehicle. More specifically, the operator may wish to select that the mode of behavior is the remainder of the current key cycle. In another example of such an embodiment, the mode of behavior may begin immediately and last for a specified duration of time. In this example embodiment, to configure a fuel saving setting with an immediate mode of behavior, the operator selects input 224, “Specify Duration for Current Mode of Behavior.” For such an embodiment, the fuel saving optimization system activates the fuel saving configuration immediately upon creation, and will deactivate the configuration when the specified duration of time is completed. In another example embodiment of an immediate mode of behavior, the operator specifies that the mode of behavior begins immediately and continues until the operator modifies the fuel saving configuration.

In certain embodiments, the operator may wish to define a different mode of behavior by selecting input 226, “Provide a Different Mode of Behavior.” It should be appreciated that in certain alternative embodiments, the vehicle fuels saving optimization system provides certain preset modes of behavior for the operator to select from and modify. In certain embodiments, the operator inputs the mode of behavior directly to the HMI system.

In continuing with the example embodiment described above, in this example embodiment, the delivery truck operator selects input 220 to “Define the Region for Configuration.” Specifically, in this example embodiment, the delivery truck operator specifies the geographic region within which he makes deliveries. In this embodiment, the operator may define this region by defining a GEOFENCE or though the vehicle ADAS.

Turning back to FIG. 1, after receiving the operator's indication of the mode of behavior, the process 100 includes receiving the operator's indication of a trigger for the fuel saving configuration, as indicated by block 106. More specifically, although the mode of behavior defines a specific location or region within which the fuel saving configuration may be activated, the trigger defines the event that will cause the fuel saving optimization system to modify specific devices. In other words, once within the mode of behavior, is there a triggering condition upon which the fuel saving optimization system should activate the fuel saving configuration? The mode of behavior establishes a location and/or timing for a fuel saving configuration. The trigger establishes the specific circumstance or condition under which the fuel saving configuration is to be activated. For example, while in a specific mode of behavior, the trigger may be loading/unloading passengers/merchandise at a delivery point. In another example, a trigger may be when the operator enters or exits the vehicle.

Turning to FIG. 2C, which illustrates a screenshot of a trigger selection menu of the fuel saving optimization system of this example embodiment. In this example embodiment, the message box 202 states, “PLEASE SELECT A TRIGGER FOR THIS MODE OF OPERATION.” FIG. 2C illustrates a few examples of triggering events such as: (a) when the operator exists a vehicle, as indicated by input 230, (b) when the operator re-enters the vehicle, as indicated by input 232, (c) when the vehicle door opens, as indicated by 234, (d) when the vehicle door closes, as indicated by 236, (e) weather related triggers, as indicated by 238, (e) traffic related triggers, as indicated by 240. It should be appreciated that the example triggers illustrated in FIG. 2C are merely a sample of examples for illustrate purposes only. Alternative embodiments may include more, fewer, and/or different triggers for an operator to select and/or input.

The weather related triggers 238 represent triggers for events such as rain, snow, extreme sun, etc, while in the mode of behavior. Traffic related triggers 240 represent triggers based on traffic congestion within the mode of behavior. More specifically, in certain embodiments, the fuel saving optimization system and method of the present disclosure also includes utilizing information of weather conditions and road traffic congestion of a specified location along with the operator input parameters to optimize fuel saving.

Continuing with the example discussed above, the delivery truck operator selects certain triggers, or events, that occur while the delivery truck operator is out making deliveries within the specified region. For example, the operator selects a first trigger to be when the operator exits the vehicle, as indicated by input 230. By making this selection, the operator set the trigger as any time the operator exits the vehicle (such as to make a delivery) while the vehicle is within the specified region.

Turning back to FIG. 1A, for each selected trigger, the process 100 includes receiving the operator's indication of a configurable device for which to provide fuel saving settings, as indicated by block 108.

FIG. 2D illustrates a screenshot of configurable device menu for this example embodiment. Message box 202 states “WHEN THE OPERATOR EXITS THE VEHICLE, PLEASE SELECT THE DEVICE(S) BELOW TO CONFIGURE.” As illustrated in FIG. 2D, in this example embodiment, the configurable devices include: (a) a climate set-point, as indicated by input 302, (b) HVAC blower fan speed, as indicated by input 304, (c) radio, as indicated by input 306, (d) front/rear windshield wipers, as indicated by input 308, (e) exterior lighting, as indicated by input 310, (f) interior lighting, as indicated by input 312, (g) interior power points, as indicated by input 314, (h) seats (heating/cooling), as indicated by input 316, (i) heat windshield, as indicated by input 318, (j) navigation, as indicated by input 320, (k) modems, as indicated by input 322, (l) cameras, as indicated by input 324, (m) radars, as indicated by input 326, (n) electronic parking brake, as indicated by input 328, and (o) engine, as indicated by input 330. It should be appreciated that these devices represent the configurable devices for this example embodiment of the present disclosure and that alternative embodiments may include fewer, more, and/or different configurable devices.

After the operator selects the configurable devices for which to modify fuel saving settings, the process 100 includes receiving the operator's indication of the operation for each of the selected device(s), as indicated by block 110. For example, the operation for each selected device may include turning the device on or off, or placing the device on standby, or temporarily idling the device.

Turning to FIG. 2E, which illustrates a screen shot of the fuel saving optimization system of the present disclosure enabling the operator to define the operation of each selected device. Continuing with the example embodiment described above, as illustrated in FIG. 2E, for the trigger of when the operator exits the vehicle, the operator selects three configurable devices: the radio 306, the interior lighting 312, and the navigation system 320. After selecting these devices, the operator defines the operation of each of these devices when the fuel saving optimization system determines that the vehicle is in the predefined region and the operator has exited the vehicle. More specifically, in this example embodiment, as illustrated in FIG. 2E, for each of the selected devices, the fuel saving optimization system prompts the operator to select whether the device should remain “ON,” as indicated by 340a, or “OFF,” as indicated by 340b. For the Navigation system, the fuel saving optimization system provides the operator with a third option to place the navigation system on “STANDBY” as indicated by 340c rather than keep the system on or turn the system off completely.

In this example embodiment, the fuel saving optimization system further prompts the operator to provide a duration for each operation. More specifically, in this example embodiment, for each of the devices, the fuel saving optimization system prompts the operator to select either “UNTIL RE-ENTRY,” as indicated by 342a, or “ENTIRE TIME,” as indicated by 342b. It should be appreciated that in this example embodiment, the delivery truck operator will be exiting the vehicle for deliveries and may remain away for a period of time while unloading and delivering the goods. While the operator is away from the vehicle, the operator may wish to have the radio turn off, and all interior lighting turn off, and have the navigation system on standby. The operator may prefer that each of the devices remain off until the operator re-enters the vehicle. In certain alternative embodiments, the operator may want one of the devices to remain in the altered state for a limited duration. For example, if the delivery takes longer than 5 minutes, the operator may want the navigation system to remain idle for 5 minutes and then restart so that the operator is able to use the navigation system immediately upon re-entry. According to this example embodiment, the delivery truck operator may do so as described herein.

In this example embodiment, the operator selects three devices at the same time to configure. In certain alternative embodiments, the fuel saving optimization system may enable the operator to select one device at a time and configure each setting.

It should be appreciated that certain fuel saving configurations may include more than one triggering event. For example, the operator may configure certain devices to operate in one manner when the driver exits the vehicle, and the operator may define a different set of device operations for a different trigger such as when the vehicle door is open. As such, after the fuel saving optimization system receives an operator's indication of the operation for the selected devices, the process 100 includes determining whether the operator wishes to configure another triggering event, as indicated by diamond 112.

If the fuel saving optimization system of the present disclosure determines that the operator wishes to configure another trigger, the process 100 includes returning to block 106 to receive another operator indication of another trigger for the fuel saving configuration. If, on the other hand, the fuel saving optimization system of the present disclosure determines that the operator does not wish to indicate another trigger for the fuel saving configuration, the fuel saving configuration is completed, as indicated by block 114.

The operator has defined a specific fuel saving configuration that indicates a mode of behavior for when and where this fuel saving configuration may be activated, specific trigger events that indicate when each of the individual settings of the fuel saving configurations are to be triggered, and the operator has specified exactly how each configurable device is to operate under these circumstances.

It should be appreciated that these configurations are both to support improved fuel economy for the vehicle and also to support comfort, convenience, and safety for the operator and other occupants of the vehicle.

After completing the process of creating the fuel saving configuration, the process 100 includes determining whether the operator wishes to execute the fuel saving configuration, as indicated by diamond 116. If the fuel saving optimization system determines that the operator does not wish to execute the fuel saving configuration, the process 100 includes saving the fuel saving configuration for future retrieval, as indicated by block 120. In certain embodiments, the operator may create a plurality of fuel saving configurations at all once, and save all of the fuel saving configurations prior to any trip. In such an embodiment, the fuel saving optimization system accesses the stored fuel saving configuration and executes the fuel saving configuration when the vehicle enters a specified mode of behavior (as described in greater detail below in connection with FIG. 1B).

If, on the other hand, the fuel saving optimization system determines that the operator wishes to execute the fuel saving configuration, the process 100 includes executing the fuel saving configuration, as indicated by block 116. That is, in certain embodiments, the operator may create each fuel saving configuration in real time and executes the fuel saving configuration for the current trip or key cycle. More specifically, the fuel saving optimization system determines that the vehicle is within the mode of behavior of the newly created fuel saving configuration, and executes the configuration when fuel saving optimization system determines that a triggering event pursuant to the configuration occurs. To execute a fuel saving configuration, the fuel saving optimization system communicates with the various electronic control units of the vehicle control system 500 described below in connection with FIG. 4. The fuel saving optimization system communicates with the electronic control unit that controls the specific device, and communicates the operation command as specified by the operator.

After executing the fuel saving configuration, the process 100 includes saving the fuel saving configuration for future retrieval, as indicated by block 120. In certain embodiments, when fuel saving configurations are stored for later retrieval, they are saved in a database in a memory of the vehicle control system 500. In certain embodiments, an operator may access a list of any previously programmed and stored selections through the vehicle HMI interface.

It should be appreciated that the process 100 illustrates one manner of creating a fuel saving configuration. In certain alternative embodiments, a operator creates a fuel saving configuration by modifying an existing, factory default fuel saving configuration. More specifically, in one example of such an embodiment, an operator may select an existing default fuel saving setting and modify the selected setting for a specific mode of behavior. In this embodiment, the operator may add triggers to the default fuel saving setting, or the operator may add or remove certain devices for the fuel saving setting.

FIGS. 1A, and 2A to 2D, illustrate an example of operating one embodiment of the fuel saving optimization system of the present disclosure to create a new fuel saving configuration. After one or more fuel saving configurations have been created and stored, various embodiments of the fuel saving optimization system of the present disclosure provide many different way to execute, or activate, each fuel saving configuration. For example, as shown in FIG. 1A, in certain embodiments, the fuel saving optimization system enables an operator to execute a fuel saving configuration in real time as the operator creates the configuration.

In certain alternative embodiments, the fuel saving optimization system detects that a fuel saving configuration has been implicated when the vehicle enters a mode of behavior associated with a stored fuel saving configuration. FIG. 1B illustrates a flow chart of process 150 of the fuel saving optimization system of the present disclosure. In this example embodiment, process 150 includes the vehicle fuel saving optimization system detecting that a stored fuel saving configuration has been implicated, and activating the stored fuel saving configuration. In various embodiments, process 150 is represented by a set of instructions stored in one or more memories and executed by one or more processors (such as those described in connection with FIG. 4). Although process 150 is described with reference to the flowchart shown in FIG. 1B, many other processes of performing the acts associated with process 150 may be employed. For example, the order of certain of the illustrated blocks may be changed, certain of the illustrated blocks may be optional, or certain of the illustrated blocks may not be employed.

The process 150 includes storing one or more fuel saving configurations, as indicated by block 152. In certain embodiments, fuel saving configurations are stored through a process such as the process 100 described in connection with FIG. 1A. In certain embodiments, the fuel saving configurations are stored in a database in a memory of the vehicle control system 500, as described in greater detail in connection with FIG. 4. As described above, these stored fuel saving configurations may be preconfigured by the operator or configured by the operator in real time as also described in connection with FIG. 1A.

After one or more fuel saving configurations have been stored, the process 150 includes the fuel saving optimization system of the present disclosure detecting that a stored fuel saving configuration has been implicated, as indicated by block 154. As described in greater detail in connection with FIG. 1A, each stored fuel saving configuration is associated with a mode of behavior, which describes a locale, or destination within which the fuel saving configuration is to be executed. In certain embodiments, the fuel saving optimization system of the present disclosure detects that a stored fuel saving configuration has been implicated by detecting the vehicle location. More specifically, the fuel saving optimization system detects that the vehicle has entered a specific location or region (i.e., a mode of behavior) associated with a stored fuel saving configuration—also referred to as a preconfigured mode of behavior.

In certain embodiments, the fuel saving optimization system determines that the vehicle has entered a preconfigured mode of behavior without input from an operator. For example, though the vehicle navigation system, global positioning system, ASDA system, the fuel saving optimization system determines that the vehicle is within a specified mode of behavior. In another embodiment, the fuel saving optimization system determines that the vehicle has entered a particular preconfigured mode of operation through an operator input. For example, upon entering a preconfigured mode of behavior, such as a delivery region, the operator may select an input on the vehicle HMI notifying the vehicle that it has entered that mode of behavior. It should be appreciated that when the vehicle enters a preconfigured mode of behavior, any stored fuel saving configuration that includes that mode of behavior has been implicated.

Once the vehicle enters a preconfigured mode of behavior, the process 150 includes determining whether the current fuel saving settings of the vehicle match the implicated fuel saving configurations, as indicated by block 154. More specifically, the fuel saving optimization system compares the current operating fuel saving settings with the preconfigured fuel saving settings for the implicated fuel saving configurations.

If the current fuel saving settings match the implicated fuel saving configurations, the fuel saving optimization system continues operating the current fuel saving settings, as indicated by 158. If, on the other hand, the fuel saving optimization system determines that the current fuel saving settings do not match the implicated fuel saving configurations, the fuel saving optimization system activates the implicated fuel saving configuration, as indicated by block 160.

It should be appreciated that activating the fuel saving configuration does not necessarily mean any immediate changes to the fuel saving settings. After the fuel saving optimization system activates the implicated fuel saving configuration, the fuel saving optimization system determines whether a trigger event occurs, as indicated by diamond 162. As described above, in connection with FIG. 1A, each stored fuel saving configuration is associated with a mode of behavior, and a trigger within that mode of behavior. The trigger is an event or an action that takes place and upon that event or action taking place, the fuel saving optimization system operates the specified devices according to the preconfigured operations to save fuel. If the trigger event has not yet occurred, the fuel saving optimization system is on standby until it determines that a trigger event occurs.

If the fuel saving optimization system determines that a trigger event occurs, the process 150 includes configuring the device(s) according to the predefined operation setting based on the implicated fuel saving configuration, as indicated by block 164. To configure the device(s) according to the fuel saving configuration, the fuel saving optimization system communicates with the various electronic control units of the vehicle control system 500 described below in connection with FIG. 4. The fuel saving optimization system communicates with the electronic control unit that controls the specific device, and communicates the operation command as specified by the operator.

In certain embodiments, the fuel saving optimization system continues to operate under these settings until the vehicle is no longer within the current mode of behavior. More specifically, the fuel saving optimization system determines whether the vehicle is out of the mode of behavior associated with the currently applied fuel saving configuration, as indicated by diamond 166. If not, the process 150 includes continuing with the fuel saving configuration that has been activated.

If, on the other hand, the fuel saving optimization system determines that the vehicle is out of the mode of behavior associated with the currently applied fuel saving configuration, the process 150 includes ending the current fuel saving configuration, as indicated by block 168. Thus, if the operator has a certain fuel saving configuration for when the operator is within a region for deliveries, once the driver is out of the region (i.e., back at the base) the fuel saving optimization system ends the fuel saving configurations associated with the delivery region.

In certain alternative embodiments, the fuel saving optimization system continues to operate under these settings until the operator deactivates the current fuel saving configuration. For example, in such an embodiment, the operator manually changes the fuel saving configurations once they have been activated.

As described in connection with the various embodiments described above, the input to the fuel saving optimization system provided by the operator may be provided in real time or may be retrieved via past travel history data on a particular route which is stored in a database. In certain embodiments, when the fuel saving optimization system detects that the vehicle has entered a location or region (i.e., a mode of behavior) that implicates a stored fuel saving configuration, the fuel saving optimization system prompts the operator regarding the fuel saving configuration.

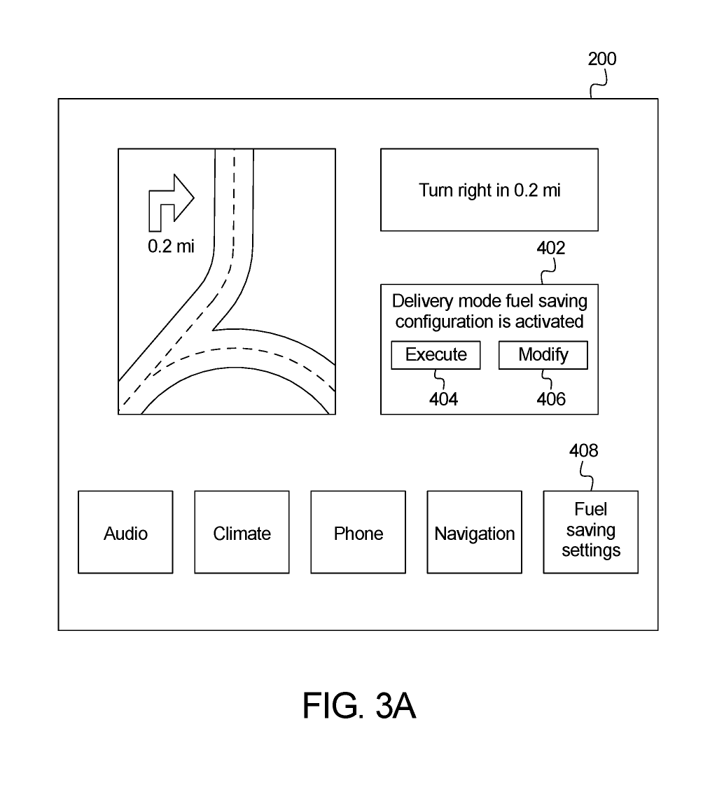

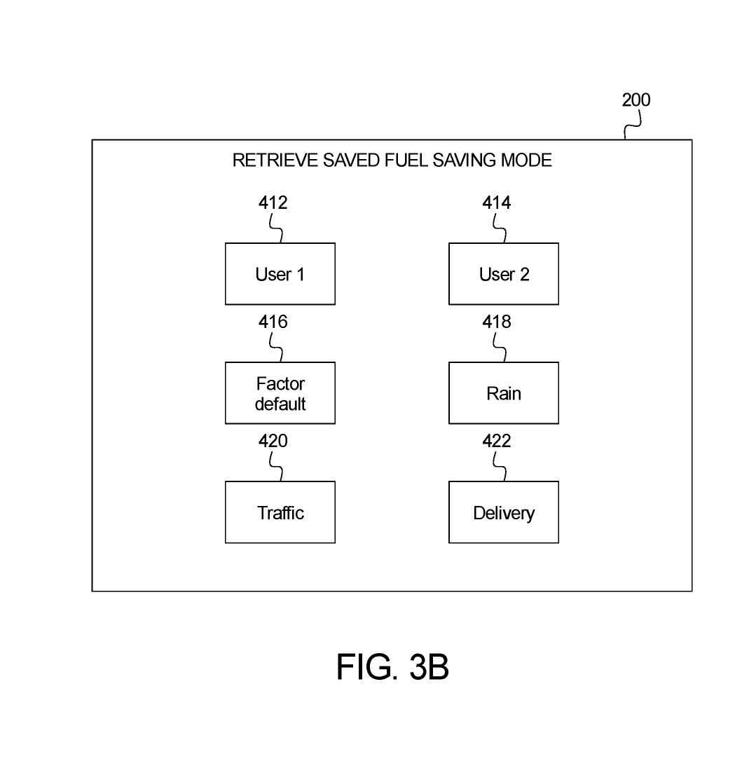

For example, FIG. 3A illustrates a screenshot of an example embodiment where the fuel saving optimization system detects that the vehicle has entered a mode of behavior and as such, a fuel saving configuration has been implicated. The fuel saving optimization system prompts the operator with a message 402, which states: “DELIVERY MODE FUEL SAVING CONFIGURATION IS DETECTED.” In this example embodiment, the fuel saving optimization system enables the operator to select input 404 “Execute,” or input 406, “Modify.” If the operator selects to execute the detected fuel saving configuration, by selecting the “execute” input 404, the fuel saving optimization system executes the fuel saving configuration.

On the other hand, if the operator selects to modify the fuel saving configuration by selecting the “modify” input 406, the fuel saving optimization system enables the operator to modify the detected fuel saving configuration. More specifically, in one example of such an embodiment, the fuel saving optimization system displays a list of the mode of behavior and any specified triggers for that mode of behavior. For each trigger, the fuel saving optimization system in this example embodiment also displays a list of selected devices and the operations for each device. The operator may select to modify one or more of these settings. For example, if one of the settings included turning on heated seats when the operator is within range of the vehicle, and it is a warm day where the operator wishes to have the heated seats remain off all day, the operator may modify this setting. After receiving all modification, the fuel saving optimization system of this example embodiment, executes the modified fuel saving configuration.

It should be appreciated that in certain embodiments, the fuel saving optimization system may enable the operator to save the modified fuel saving configuration as a new fuel saving configuration. In certain embodiments, the fuel saving optimization system may enable the operator to replace the original fuel saving configuration with the modified fuel saving configuration.

In this embodiment, if the operator chooses not to execute or modify the detected fuel saving configuration, the fuel saving optimization system continues with the currently operating fuel saving settings. In certain alternative embodiments, even if the operator does not select an input, the fuel saving optimization system automatically executes the implicated fuel saving configuration.

FIGS. 1A, 1B, 2A to 2D, and 3A illustrate an example of operating one embodiment of the fuel saving optimization system of the present disclosure to create, store, and/or activated a fuel saving configuration specified by the operator. In certain embodiments, the fuel saving optimization system of the present disclosure provides recommendations for fuel saving configurations to the operator.

For example, FIG. 1C illustrates a flow chart of process 180 of the fuel saving optimization system of the present disclosure. In this example embodiment, process 180 includes the vehicle fuel saving optimization system providing recommendations for fuel saving configurations to the operator and enabling the operator to accept or modify the recommended fuel saving settings, or to create new fuel saving configurations based on the recommendations. In various embodiments, process 180 is represented by a set of instructions stored in one or more memories and executed by one or more processors (such as those described in connection with FIG. 4). Although process 180 is described with reference to the flowchart shown in FIG. 1C, many other processes of performing the acts associated with process 150 may be employed. For example, the order of certain of the illustrated blocks may be changed, certain of the illustrated blocks may be optional, or certain of the illustrated blocks may not be employed.

In operation, the process 180 includes the fuel saving optimization system determining recommended fuel saving settings for the vehicle based on the current vehicle location, environment and/or previously stored operator preferences. More specifically, the fuel saving optimization system may provide recommended fuel saving configurations based on the location of the vehicle (i.e., if the vehicle is on the freeway), or the environment (i.e., if it has stopped raining) and/or previously stored operator preferences (i.e. based on past travel history data of fuel saving configurations by the operator on a particular route which is stored in a database).

After determining recommended fuel saving settings for the vehicle, the process 180 includes presenting the operator with the recommended fuel saving settings, as indicated by block 184. More specifically, in one embodiment, the fuel saving optimization system presents the recommended fuel saving settings through a message window on the vehicle HMI. In certain alternative embodiments, the fuel saving optimization system may present the recommended settings audibly through speakers in the vehicle. In various embodiments, the fuel saving optimization system may present the recommended settings to the operator in any other suitable manner.

Once the fuel saving optimization system has presented the recommended fuel saving setting to the operator, the process 180 includes enabling the operator to accept the recommended fuel saving settings, modify the recommended fuel saving settings, or create a new fuel saving configuration, as indicated by block 186. More specifically, in one embodiment, the fuel saving optimization system may suggest the recommended fuel saving configurations. For example, the fuel saving optimization system may recommend that the operator turn off the heated windshield as the temperature has risen to where the heated windshields are no longer necessary. In this example embodiment, the fuel saving optimization system may present a message window through the vehicle HMI that includes this recommended setting.

The process 180 then includes determining whether the operator accepted the recommended fuel saving configurations, as indicated by diamond 188. In continuing with the example described, above, the fuel saving optimization system determines whether the operator accepts the recommendation to turn off the heated windshield. If the operator accepts the recommended fuel saving configurations, the process 180 includes executing the recommended settings, as indicated by block 190. More specifically, in this example, if the operator accepts, the fuel saving optimization system turns off the heated windshield.

If, on the other hand, the operator does not accept the recommended fuel saving configurations, the process 180 includes determining whether the operator selected to modify the recommended fuel saving configurations, as indicated by diamond 192. More specifically, in this example, the operator may modify the recommended fuel saving configuration by adding a duration for the heated windshield to be turned off. Alternatively or additionally, in this example, the operator may modify the recommended fuel saving configuration by adding additional fuel saving configurations (i.e., also turn off the heated seats), etc. If the operator selects to modify the recommended fuel saving configurations, the process 180 includes enabling the operator to modify the recommended settings and executing the modified settings, as indicated by block 194.

If, on the other hand, the operator does not select modifying the recommended fuel saving configurations, the process 180 includes determining whether the operator selected to create a new configuration, as indicated by diamond 196. In this example embodiment, the operator may wish to create an entirely new fuel saving configuration that may or may not be based on the recommended fuel saving configuration. If the operator selects creating a new fuel saving configurations, the process 180 includes returning to FIG. 1A, as indicated by block 198. More specifically, the fuel saving configuration enables the operator to create a new fuel saving configuration through a processes such as the process described in connection with FIG. 1A.

If, on the other hand, the operator does create a new fuel saving configuration (and did not accept or modify the recommended fuel saving configurations), the process 180 includes continuing with the current fuel saving configurations, as indicated by block 199. More specifically, in certain embodiments, the fuel saving optimization system may suggest certain recommended fuel saving configurations and the operator may select to ignore the recommendations entirely. It should be appreciated that the fuel saving optimization system is intended to both enhance fuel economy and provide the operator control of the fuel saving settings. As such, even if a recommended fuel saving configuration may enhance fuel economy, the operator may select not to activate such a setting.

Turning back to FIG. 3A, it should further be appreciated that in this example embodiment, the operator is not on the fuel saving settings home screen, such as those illustrated in connection with FIGS. 2A to 2E. As illustrated in the depicted embodiment in FIG. 3A, the operator is using a vehicle navigation system as indicated by the majority of the image on the display 200. In this example embodiment, even though the operator has not explicitly called up the fuel saving optimization display, the fuel saving optimization system displays the message box 402 upon detecting that the vehicle is within a new mode of behavior. As such, in certain embodiments, the fuel saving optimization system is operating even when the operator is not aware of it or the operator has not specifically called up the fuel saving optimization system.

In certain embodiments, the operator can access the fuel saving setting home screens such as those illustrated in FIGS. 2A to 2E, by selecting the application through the vehicle HMI. For example, as further illustrated at the bottom of the display 200 on FIG. 3A includes a series of options that the operator may select to execute various applications of the vehicle. Option 408 is for the “Fuel Saving Settings.” In this embodiment, but selecting this option, the operator may access the full menu of options for the fuel saving optimization system of the present disclosure.

It should be appreciated by the example embodiments described above that the fuel saving optimization system includes many different ways of obtaining the operator's fuel saving preferences for the vehicle. In certain embodiments, the operator can choose the stored preference according to the route traversed or the vehicle fuel saving optimization system can adapt or learn the preference over time and execute the preferences automatically.

In addition to enabling a operator to create and store fuel saving configurations, various embodiments of the fuel saving optimization system of the present disclosure also enable a operator to offload fuel saving configuration data. In certain embodiments, the fuel saving optimization system enables operators to transfer fuel saving configuration data to use external software to analyze fuels saving data to provide insight on the impact of settings on fuel economy that would be achieved for other similar vehicles and to optimize fuel saving setting for other similar functions. For example, if a fleet operator provides stored settings, those settings may be used to modify the factory default settings for vehicles that are being designed to operate under similar circumstances.

In certain embodiments, the fuel saving optimization system stores operator preferences on-board or off-board. In certain embodiments, the stored fuel saving configurations may be offloaded to an external application. For example, in certain embodiments, this is done wirelessly. In certain embodiments, the settings may be offloaded to an external USB on a key fob, or other portable data storage device. In certain embodiments, the fuel saving optimization system enables operators to offload data so that the operators may transfer the data to other vehicles.

In certain embodiments, the settings may be off loaded to an internal application. For example, in one embodiment, the data is off loaded to a memory within the vehicle control system (such as those described in connection with FIG. 4) where the data is stored and categorized for different operators. Such a configuration would be beneficial in applications where more than one operator operates the same vehicle.

Whether the data is offloaded to an internal or external application, the data may be retrieved by a vehicle operator through the fuel saving optimization system of a vehicle. For example, FIG. 3B illustrates a screen shot for an HMI display 200 for a “Retrieve Saved Fuel Saving Mode” home screen. More specifically, in this example embodiment, after a operator selects a menu option to retrieve saved fuel saving configurations from a previous screen (not shown), the fuel saving optimization system displays several retrieval options such as those depicted in FIG. 3B. For example, in this embodiment, the fuel saving optimization system enables the operator to select “Operator 1,” as indicated by 412, or “Operator 2,” as indicated by 414. The fuels saving optimization system retrieves any previously set fuel saving configurations for the respective operator. In one embodiment, the fuel saving optimization system does so from in-vehicle storage device or form wireless/cellular connection to database. Additionally or alternatively, in this example embodiment, the operator may select “Factory Default” as indicated by 416 to access a list of the factory default settings. The operator may wish to execute one of the factory default settings or may wish to modify one of the factory default settings.

As further illustrated in FIG. 3B, the display 200 includes certain short cut inputs for common modes of behavior or triggers such as “Rain,” as indicated by 418, or “Traffic,” as indicated by 420 for the operator to be able to quickly select a fuels saving configuration when in those situations. In such an embodiment, the operator does not have to go through all of the steps of creating or modifying any existing fuels saving configurations. It should be appreciated that these short cut options 418, 420 are merely illustrations and are not intended to be limiting. For example, other similar short cuts may include “Snow,” “Ice,” “Outside Temperature Below 30° C.,” and many other options. Each short cut provides the operator the ability to quickly access, modify, and/or execute fuel saving configurations that are appropriate for a specific environment.

The operator may also create customized short cuts such as “Delivery,” as indicated by 422. For example, if the operator uses the same vehicle for personal use and for making deliveries, the operator may wish to have a quick access short cut such as 422 that the operator may select at any time to switch to a delivery mode with preconfigured fuels saving configurations.

In addition to the illustrated examples, various embodiments of the present disclosure include different ways of enabling the operator to alter the settings. In certain embodiments, the current fuel saving settings are depicted on the home screen of the HMI system so that the operator can access the current settings immediately. In certain embodiments there are short cuts for frequently used devices, or frequently used operating modes.

Such a configuration provides operator satisfaction, as a product of fuel savings. In certain embodiments, as described above, the fuel saving optimization system enables the operator-signaled inputs indicated preference to be provided real-time (i.e., at a given location/in a given environment/at a specific time of day/etc.). In certain embodiments, the fuel saving optimization system provides the operator suggestions for improvements to the fuel saving settings in real time. For example, in certain embodiments, the fuel saving optimization system prompts the operator if there is a better fuel saving configuration available under certain conditions. For example if the operator entered a region, or encounters a weather condition.

In certain embodiments, the fuel saving optimization system determines and signals fuels saving configurations after a trip is completed via post processing of vehicle trip information (locations, time spent at locations, or route or history of environmental conditions encountered). More specifically, in certain embodiments, the fuel saving optimization system allows the operator to strategize the best possible solution for various modes of behavior. For example, in one embodiment, the fuel saving optimization system assists the operator in determining optimized fuel saving configurations though computational algorithm. More specifically, in one embodiment, after a trip is completed, the fuel saving optimization system of the present disclosure provides the operator with suggestions of how to optimize fuel economy for a future similar trip. In another embodiment, the fuels saving optimization system may use previously collected data to offer the operator suggestions in real time of ways to improve fuel economy during a trip. For example, the fuel saving optimization system may notify the operator that windshield heater is currently using fuel when there is no need to have that device on. The operator can then respond to any prompt from the fuels saving optimization system to modify existing fuel saving settings.

In another embodiment, the operator manually selects fuel saving configurations during post-processing after completing a trip. Data can be transmitted to vehicle storage options described above.

Referring now to FIG. 4, shown is an example vehicle control system (VCS) 500 that may be included in the vehicle to carry out the method 100 for operating the fuel optimization system of the present disclosure. The VCS 500 includes various electronic control units (ECUs) that are responsible for monitoring and controlling the electrical systems or subsystems of the vehicle, as described in more detail below. Other embodiments of the fuel saving optimization system may include different, fewer, or additional components than those described below and shown in FIG. 4.

As shown in FIG. 4, the VCS 500 can include a data processor 502 in communication with and a memory 504 (also referred to herein as a data storage device) and a vehicle data bus 506. The memory 504 stores a set of instructions. The processor 502 is configured to communicate with the memory 504, access the set of instructions, and execute the set of instructions to cause the fuel saving optimization system to perform any of the methods, processes, and features described herein.

The processor 502 may be any suitable processing device or set of processing devices such as, but not limited to: a microprocessor, a microcontroller-based platform, a suitable integrated circuit, or one or more application-specific integrated circuits (ASICs). The memory 504 may be any suitable memory device such as, but not limited to: volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, memristor-based non-volatile solid-state memory, etc.); unalterable memory (e.g., EPROMs); or read-only memory.

In embodiments, the VCS 500 can comprise a general purpose computer that is programmed with various programming instructions or modules stored in the data storage device 504 (e.g., electronic memory), or elsewhere. The VCS 500 further includes various electronic control units (ECUs) that are responsible for monitoring and controlling the electrical systems or subsystems of the vehicle. Each ECU may include, for example, one or more inputs and outputs for gathering, receiving, and/or transmitting data, a memory for storing the data, and a processor for processing the data and/or generating new information based thereon. In the illustrated embodiment, the ECUs of the VCS 500 include a fuel saving optimization system (FSO) 508, a telematics control unit (TCM) 510, a body control module (BCM) 512, a human-machine interface (HMI) 514, a power train control module (PCM) 516, and various other ECUs 506.

The ECUs of the VCS 500 can be interconnected by the vehicle bus 506 (such as, e.g., a controller area network (CAN) bus), which passes data to and from the various ECUs, as well as other vehicle and/or auxiliary components in communication with the VCS 500. Further, the data processor 502 can communicate with any one of the ECUs and the data storage device 504 via the data bus 506 in order to carry out one or more functions, including the functions associated with methods described herein.

The fuel saving optimization (FSO) system 508 is an ECU configured to for controlling and monitoring fuel saving parameters for the vehicle. The fuel saving optimization system 508 includes a processor 520 in communication with a memory 522 storing a plurality of instructions 524, similar to the processor 502 and memory 504 of the vehicle control system 500 as described above. In some embodiments, the FSO 508 is a separate, stand-alone ECU that is interconnected to the BCM 512, PCM 516, TCU 510, and other ECUs of the vehicle via the vehicle bus 506 in order to carry out the fuel saving operations. For example, the FSO 508 may receive commands from an operator via the TCU 510, process the commands to identify the appropriate ECU for carrying out the command, send the command to the identified ECU, and confirm performance of the command. In other embodiments, the FSO 508 may be comprised of multiple segments that are incorporated into various ECUs of the VCS 500, such as, for example, the BCM 512, the PCM 516, and/or the TCU 510, to process the FSO commands received at each ECU. In still other embodiments, the FSO 508 may be included within one ECU, such as, e.g., the TCU 510, in order to handle or process FSO commands as they are received by the TCU 510.

The body control module (BCM) 512 is an ECU for controlling and monitoring various electronic accessories in a body of the vehicle. In embodiments, the BCM 512 is an ECU that controls the doors of the vehicle including locking, unlocking, opening, and/or closing said doors. In some embodiments, the BCM 512 also controls the power windows, power roof (e.g., moonroof, sunroof, convertible top, etc.), and interior lighting of the vehicle. The BCM 512 may also control other electronically-powered components in the body of the vehicle, such as, for example, air-conditioning units, power mirrors, and power seats. In cases where the BCM 512 only controls and monitors the doors of the vehicle, the BCM 512 may be referred to as the door control unit (DCU), as will be appreciated. The BCM 512 can be configured to implement commands received from the FSO 508 that are related to the doors, windows, or other body components controlled by the BCM 512.

The power train control module (PCM) 516 is an ECU for controlling and monitoring the engine and transmission of the vehicle. In some embodiments, the PCM 516 can be separated into two separate ECUs, specifically an engine control unit and a transmission control unit. In either case, the PCM 516 can be configured to control starting and stopping of the engine of the vehicle, and may implement commands to start the engine received from the FSO 508.

The telematics control unit (TCU) 510 is an ECU for enabling the vehicle to connect to various wireless networks, including, for example, ASDA, GPS, WiFi, cellular, Bluetooth, NFC, RFID, satellite, and/or infrared. In embodiments, the TCU 510 (also referred to as a “vehicle telematics unit”) includes a wireless communication module 518 comprising one or more antennas, radios, modems, receivers, and/or transmitters (not shown) for connecting to the various wireless networks. For example, the wireless communication module 518 may include, but is not limited to, a mobile communication unit (not shown) for wirelessly communicating over a cellular network (e.g., GSM, GPRS, LTE, 3G, 4G, CDMA, etc.), an 802.11 network (e.g., WiFi), a WiMax network, Bluetooth, and/or a satellite network. The TCU 510 can also be configured to control tracking of the vehicle using latitude and longitude values obtained from standard systems including, but not limited to, a GNSS satellite systems (e.g., GPS, GLONASS, BeiDou, Galileo, QZSS, SBAS, etc.). In a preferred embodiment, the wireless communication module 518 includes a Bluetooth or other short-range receiver (not shown) for receiving vehicle commands and/or data transmitted by the FSO 508, and a Bluetooth or other short-range transmitter (not shown) for sending data to the FSO 508.

In embodiments, the TCU 510 receives external data via the wireless communication module 518 and provides the external data to an appropriate ECU of the VCS 500. For example, if the TCU 510 receives turn off exterior lights command from an operator, the TCU 510 sends the command to the BCM 512 via the vehicle bus 506. Likewise, if the TCU 510 receives a start engine command, the TCU 510 sends the command to the PCM 516 via the vehicle bus 506. In some embodiments, the TCU 510 also receives internal data from other ECUs of the VCS 500 and/or the data processor 502, with instructions to transmit the internal data to the vehicle, or another component of the FSO system of the present disclosure.

The human-machine interface (HMI) 514 (also referred to as a “operator interface”) can be an ECU for enabling operator interaction with the vehicle and for presenting vehicle information to the vehicle operator or driver. Though not shown, the HMI 514 can comprise an instrument panel (IP), a media display screen, as well as one or more input devices and/or output devices for inputting, entering, receiving, capturing, displaying, or outputting data associated with the vehicle control system 500, the method 100 shown in FIG. 1 or the techniques disclosed herein. The HMI 514 can be configured to interact with the other ECUs of the VCS 500 and/or the data processor 502 via the data bus 506 in order to provide information or inputs received via the HMI 514 to an appropriate component of the VCS 500 and to present, to the vehicle operator or driver, information or outputs received from the various components of the VCS 500.

Any process descriptions or blocks in the figures, should be understood as representing modules, segments, or portions of code that include one or more executable instructions for implementing specific logical functions or steps in the process, and alternate implementations are included within the scope of the embodiments described herein, in which functions may be executed out of order from that shown or discussed, including substantially concurrently or in reverse order, depending on the functionality involved, as would be understood by those having ordinary skill in the art.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle fuel saving optimization system, comprising:
a processor in communication with a memory storing a fuel saving configuration, the processor configured to:
determine a stored fuel saving configuration is implicated;
compare current vehicle fuel saving settings to the implicated fuel saving configuration; and
activate the fuel saving configuration through a vehicle control system based on the comparison.

2. The vehicle fuel saving optimization system of claim 1, wherein each fuel saving configuration is associated with a mode of behavior.

3. The vehicle fuel saving optimization system of claim 1, wherein the mode of behavior includes information about the location of the vehicle.

4. The vehicle fuel saving optimization system of claim 2, wherein the processor determines a stored fuel saving configuration is implicated when the processor determines the vehicle has entered a mode of behavior associated with a stored fuel saving configuration.

5. The vehicle fuel saving optimization system of claim 2, wherein each fuel saving configuration includes a trigger.

6. The vehicle fuel saving optimization system of claim 5, wherein each trigger is associated with one or more configurable devices.

7. The vehicle fuel saving optimization system of claim 5, wherein the process activates the fuel saving configuration upon detection of the trigger occurring when the vehicle is within the mode of operation.

8. The vehicle fuel saving optimization system of claim 1, wherein the processor is further in communication with an interface.

9. The vehicle fuel saving optimization system of claim 8, wherein the interface is configured to transmit operator inputs regarding fuel saving configuration information to a vehicle control system.

10. The vehicle fuel saving optimization system of claim 1, wherein the processor is further configured to provide fuel saving information to an operator based prior saved fuel saving configurations.

11. A method of operating a vehicle fuel saving optimization system, comprising:
storing a fuel saving configuration in a memory;
determining, by a processor, that the stored fuel saving configuration is implicated;
comparing, by the processor, current vehicle fuel saving settings to the implicated fuel saving configuration; and
activating the fuel saving configuration through a vehicle control system based on the comparison.

12. The method of operating the vehicle fuel saving optimization system of claim 11, wherein each fuel saving configuration is associated with a mode of behavior.

13. The method of operating the vehicle fuel saving optimization system of claim 11, wherein the mode of behavior includes information about the location of the vehicle.

14. The method of operating the vehicle fuel saving optimization system of claim 12, wherein the processor determines a stored fuel saving configuration is implicated when the processor determines the vehicle has entered a mode of behavior associated with a stored fuel saving configuration.

15. The method of operating the vehicle fuel saving optimization system of claim 12, wherein each fuel saving configuration includes a trigger.

16. The method of operating the vehicle fuel saving optimization system of claim 15, wherein each trigger is associated with one or more configurable devices.

17. The method of operating the vehicle fuel saving optimization system of claim 15, wherein the process activates the fuel saving configuration upon detection of the trigger occurring when the vehicle is within the mode of operation.

18. The method of operating the vehicle fuel saving optimization system of claim 11, wherein the processor is further in communication with an interface.

19. The method of operating the vehicle fuel saving optimization system of claim 18, wherein the interface is configured to transmit operator inputs regarding fuel saving configuration information to a vehicle control system.

20. The vehicle fuel saving optimization system of claim 11, wherein the processor is further configured to provide fuel saving information to an operator based prior saved fuel saving configurations.
